(19) United States
(12) Patent Application Publication
(10) Pub. No.: US 2026/0226322 A1
(43) Pub. Date: Aug. 6, 2026

(54) MULTIFUNCTIONAL BIO-BASED ADDITIVES

(71) Applicant: SOLUGEN, INC., Houston, TX (US)

(72) Inventors: Sean Hunt, Houston, TX (US); Jun Su An, Houston, TX (US); Camille Boucher-Jacobs, Houston, TX (US); Jihye Kim, Sugar Land, TX (US); Gaurab Chakrabarti, Houston, TX (US); Amit Desai, Sugar Land, TX (US)

(73) Assignee: SOLUGEN, INC., Houston, TX (US)

(21) Appl. No.: 19/127,408

(22) PCT Filed: Dec. 21, 2023
(86) PCT No.: PCT/US2023/085499

§ 371 Date: May 5, 2025

Related U.S. Application Data
(60) Provisional application No. 63/434,240, filed on Dec. 21, 2022.

(51) Int. Cl. C09J 103/02; C08K 3/34; C08K 5/00; C08K 5/21; C08K 5/55

(52) U.S. Cl. CPC C09J 103/02; C08K 3/346; C08K 5/0025; C08K 5/21; C08K 5/55

(57) ABSTRACT

A biobased multifunctional additive may include a crosslinking composition. A crosslinking composition may include an oxidized sugar product, a nitrogen additive, and a solvent. Also, a biobased multifunctional additive may include an adhesive. An adhesive may include (i) a sodium silicate solution, (ii) a sugar oxidation product; (iii) urea; (iv) clay; and (v) water. Also, an adhesive may include (i) starch; (ii) a sugar oxidation product; and (iii) a boric acid.

### CROSS-REFERENCE TO RELATED APPLICATIONS

This application is a 35 U.S.C. § 371 national stage application of PCT/US2023/085499 filed Dec. 21, 2023 and entitled “MULTIFUNCTIONAL BIO-BASED ADDITIVES,” which claims priority to U.S. Provisional Application Ser. No. 63/434,240 filed Dec. 21, 2022 and entitled “MULTIFUNCTIONAL BIO-BASED ADDITIVES,” each of which is incorporated herein by reference in its entirety for all purposes.

### TECHNICAL FIELD

The present disclosure relates generally to biobased multifunctional additives. More particularly, this disclosure relates to methods for the production and utilization of a multifunctional additive in the formation of biobased products such as fibers, crosslinkers, and adhesives.

### BACKGROUND

Additives are routinely used to impart improvements in performance properties to various commercially important materials such as plastics, rubbers, and adhesives.

Adhesives have been used in all aspects of our daily life to connect materials temporarily or permanently. Synthetic polymers have been widely used as adhesive materials due to their capability to provide good contact between surfaces and dissipate energy under stress. Adhesives are generally categorized into two types: strong adhesives or ductile adhesives. Examples of strong adhesives, which may be suitable for structural applications, include epoxies, polyurethanes, or acrylics. Strong adhesives typically provide strong adhesion, but exhibit low work of debonding due to brittleness often leading to undesired cohesive failure. In contrast, ductile adhesives, such as adhesives that are used on tape, do not have strong adhesion but can dissipate mechanical stress through a soft matrix, preventing sudden bond failure. Ductile adhesives are commonly made of low modulus materials that limit their use in structural applications. Another class of adhesives, termed “tough adhesives,” which can exhibit both characteristics of strong and ductile adhesion, are extremely rare because these combinations of adhesive properties are difficult to attain due to their conflicting nature. Tough adhesives are characterized as having a high degree of debonding force which provides improved safety and longevity of the structure while minimizing adhesive failures.

Another group of commercially important materials is crosslinkers. Crosslinking reagents (or crosslinkers) are molecules that contain two or more reactive ends capable or chemically attaching to specific functional groups on polymer molecules. Cross-linked polymers and resins have many interesting properties which make them very attractive materials. By cross-linking, the structure of a polymer solution can be fixed. The resulting polymer networks may exhibit elastic behavior and, depending on the system, good mechanical properties, and superior environmental resistance, for example, against chemicals and heat.

Phenol-formaldehyde resins (for example, resols and novolacs) are utilized as a crosslinking agent for a variety of applications in adhesives and plastics, such as for dynamic vulcanization of blends of polypropylene and ethylene-propylene-diene rubber (PP/EPDM), production of thermoplastic vulcanizates (TPVs), and bonding components of wood furniture. Many conventional crosslinkers (or crosslinking agents) are effective, but utilize phenols and formaldehyde-based binders that have Environment, Health and Safety (EHS) issues. Formaldehyde is a known irritant and allergen. Also, formaldehyde is a human carcinogen. Phenols also present various environmental health and safety issues, as its vapors are corrosive to the eyes, skin, and respiratory systems. Phenols can have lethal effects, as the fatal dose for ingestion is approximately 1-32 grams. Other known crosslinkers or binders are usually carbohydrate or sugar-based, but they have limited applications due to their viscosity and crosslinking limitations.

Another group of commercially important materials is fibers. Fibers are added to a polymer matrix to provide reinforcement. The reinforcement obtained from fibers is dependent upon the strength of the fiber, the length of the fiber, and the effectiveness of the fiber/matrix bond. In general, addition of fibers may improve the mechanical properties of plastics like tensile strength, elasticity, and heat stability. Carbon and metallic fibers are known to offer antistatic and conductive properties to the plastic. Fibrous additives can be glassy, metallic, carbonaceous, or ceramic in nature.

There exists an ongoing demand for compositions and methods that can reduce or replace the use of high carbon footprint additives currently employed to improve the performance characteristics of commercially important materials. Additionally, multifunctional compositions are desirable as they hold the potential to provide a wide array of performance enhancements across a variety of applications.

### SUMMARY

Disclosed herein are biobased multifunctional additives.

For example, in some aspects, a crosslinking composition may comprise an oxidized sugar product, a nitrogen additive, and a solvent. In some aspects, the oxidized sugar product may comprise an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof. Additionally or alternatively, in some aspects, the oxidized sugar product may comprise less than about 5 wt. % maltose, maltotriose, fructose, higher molecular weight polysaccharides, oxidation products thereof or combinations thereof based on the total weight of the sugar derivative. Additionally or alternatively, in some aspects, the nitrogen additive may comprise urea, ammonium, amine salt, diamines, melamine or a combination thereof. Additionally or alternatively, in some aspects, the solvent comprises water, methanol, ethanol, ethylene glycol, propylene glycol, ethylene glycol monobutyl ether, or a combination thereof. Additionally or alternatively, in some aspects, the solvent comprises a pH control additive.

Also disclosed herein are adhesives. In some aspects, an adhesive may comprise (i) a sodium silicate solution, (ii) a sugar oxidation product; (iii) urea; (iv) clay and (v) water. In some aspects, the sugar oxidation product may comprise an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof. Additionally or alternatively, in some aspects, the sugar oxidation product may comprises less than about 5 wt. % maltose, maltotriose, fructose, higher molecular weight polysaccharides, oxidation products thereof or combinations thereof based on the total weight of the sugar derivative.

In some aspects, an adhesive may comprise (i) starch; (ii) a sugar oxidation product; and (iii) a boric acid. In some embodiments, the sugar oxidation product may comprise an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof. Additionally or alternatively, in some aspects the sugar oxidation product may comprise less than about 5 wt. % maltose, maltotriose, fructose, higher molecular weight polysaccharides, oxidation products thereof or combinations thereof based on the total weight of the sugar derivative.

### BRIEF DESCRIPTION OF THE DRAWINGS

For a detailed description of various exemplary aspects, reference will now be made to the accompanying drawings in which:

FIG. 1 is a schematic of the formation of a lactone from glucaric acid.

FIG. 2 is a schematic of the structure of glucodialdose.

FIG. 3A is a schematic of an example of a crosslinked phenol-sugar resin.

FIG. 3B is a schematic of an example of a crosslinked urea-sugar resin.

FIG. 4 is a process flow diagram illustrating aspects of methods of the present disclosure.

FIG. 5 are Fourier-transform infrared spectroscopy with attenuated total reflection (FTIR/ATR) spectra for formaldehyde, urea and urea formaldehyde resins.

FIG. 6 are FTIR-ATR spectra for liquid gluconate, urea and liquid gluconate-urea reaction product.

FIG. 7 are FTIR-ATR spectra for Aquacore X40, urea and Aquacore X40-Urea reaction products collected at various stages of the reaction.

FIG. 8 are FTIR-ATR spectra for liquid gluconate, boric acid and the reaction product thereof.

FIG. 9 are FTIR-ATR spectra for Aquacore X40, boric acid and the reaction product thereof.

FIG. 10 are FTIR-ATR spectra for Aquacore X40, Cymel® NF3030 and the reaction product thereof.

FIG. 11 is an illustration of a system for testing shear strength of an adhesive.

### DETAILED DESCRIPTION

Disclosed herein are compositions that can be used as a multifunctional additive. In some aspects, a multifunctional additive of the present disclosure is a component of a crosslinking agent. In other aspects, a multifunctional additive of the present disclosure is a component of an adhesive. In yet other aspects, a multifunctional additive of the present disclosure is a component of a fiber. Also disclosed herein are various compositions comprising a multifunctional additive. Hereinafter, the multifunctional additives of the present disclosure, for example, which may be effective to enhance the performance of compositions and/or materials to which they are added, are collectively referred to as performance enhancing additives (PEAs).

Herein, a PEA suitable for use in the present disclosure comprises an oxidized sugar product. In an aspect, the PEA comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacid, galactonic acid, galactaric acid, glutamic acid, glucodialdose, 2-ketoglucose, glucodiamine, glycoaldehyde, glyoxal, salts thereof, lactones thereof, or combinations thereof. In such aspects, the oxidized sugar product comprises less than about 5 wt. % maltose, maltotriose, fructose, higher molecular weight polysaccharides, oxidation products thereof or combinations thereof based on the total weight of the oxidized sugar product.

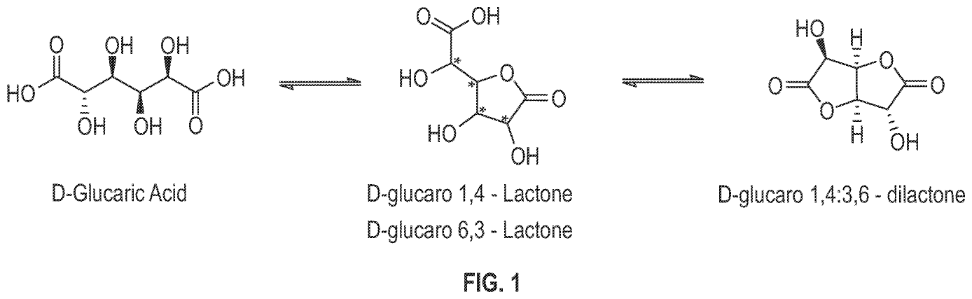

In one or more aspects, the PEA comprises glucaric acid. As shown in FIG. 1, glucaric acid may form various lactones that can be used to bind man-made mineral fibers such as fiberglass and mineral wool. Not intending to be bound by theory, the dilactone formed from glucaric acid has terminal double bond oxygens, which can serve as a platform for cross linking of these aforementioned fibers. Glucaric acid and the lactones that can be formed are depicted in FIG. 1.

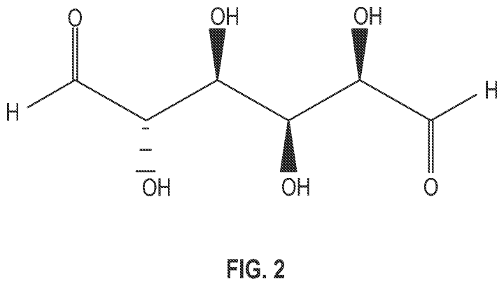

Additionally or alternatively, in some aspects, the PEA comprises glucodialdose, which is a dialdehyde and is depicted in FIG. 2. Not intending to be bound by theory, gluconic acid, glucaric acid, glucodialdose, and the various forms of these molecules, as disclosed herein, may be characterized by a high concentration of hydroxyl groups that can lead to additional crosslinking sites. Additional crosslinking sites can lead to higher concentration of crosslinking and a final higher polymer viscosity when compared to conventional crosslinkers. Additionally, the carboxyl groups present in the glucodialdose and glucaric acid can lead to further derivatization and crosslinking.

Additionally or alternatively, in some aspects, the PEA comprises a C2-C6 monoacid, a C2-C6 diacid, a partially oxidized glucose product, a glucose oxidation product, gluconic acid, glucodialdose, guluronic acid glucaric acid, glucaric acid salts, glucaric acid lactones, glutamic acid, glucodialdose, sodium gluconate, sodium glucarate, 2-ketoglucose, adipic acid, erythorbic acid, erythorbic acid salts, lactic acid, lactic acid salts, amines, amine salts, glycerol, sorbitol, mannitol, one or more derivatives thereof, or a combination thereof.

In some aspects, a PEA of the type disclosed herein may be a component of a crosslinking agent composition and is used to crosslink polymeric networks resulting in improved mechanical, thermal, and chemical properties thereof. For example, the cross-linker may increase the viscosity of a solution by connecting the separate molecules together. The cross-linker may significantly increase the viscosity of a linear gel by increasing the molecular weight of the base polymer by linking multiple molecules together. In various aspects, a PEA of the type disclosed herein may be used in the absence of one or more conventional crosslinking agents; additionally or alternatively, the PEA excludes conventional crosslinking agents; or additionally or alternatively, the PEA excludes one or more phenol-formaldehyde resins. In some aspects, the PEA may be present in an amount from about 1% to about 40% by weight of the polymer composition, additionally or alternatively, from about 1% to about 10% by weight of the composition. Also, in some aspects, the polymer, for example, a resin or thermoplastic polymer such as an epoxy, a polyester, or a polyamide, may be present in an amount from about 60% to about 99% by weight of the composition, additionally or alternatively, from about 90% to about 99% by weight of the composition.

Alternatively, in some aspects, a PEA of the type disclosed herein is used in the presence of one or more conventional crosslinking agents. For example, the PEA may be used in the presence of a phenol-formaldehyde resin, urea, melamine, boric acid, sodium silicate, glucose, dextrose, other starch-based products such as molasses, other sugar syrups, or combinations thereof. In some aspects, the PEA is used in the presence of a polycarboxylate binder such as tartaric acid, citric acid, and adipic acid.

In an aspect, a PEA may be a component of a binder. Herein a binder or binding agent is any material or substance that holds or draws other materials together to form a cohesive whole mechanically, chemically, by adhesion or cohesion.

In an aspect, a PEA is a component of an adhesive. For example, the PEA may be a component of a sodium silicate adhesive. Additionally, the adhesive may comprise additional components typically found in sodium silicate adhesives. For example, in addition to the adhesive sodium silicate solution and PEA, suitable quantities of urea, a finely divided clay and water may be included in the adhesive composition. Sodium silicate adhesives containing PEAs of the type disclosed herein may be used for bonding a variety of porous surfaces and materials such as paper, mineral wool (used in insulation), perlite, mica and wood. In some aspects, the PEA may be present in an amount from about 1% to about 40% by weight of the adhesive composition, additionally or alternatively, from about 1% to about 10% by weight of the adhesive composition. Also, in some aspects, the sodium silicate may be present in an amount from about 60% to about 99% by weight of the adhesive composition, additionally or alternatively, from about 90% to about 99% by weight of the adhesive composition.

In another aspect, a PEA is component of a boric acid containing adhesive. Boric acid is often included in starch based adhesives to impart improved properties such as an increased viscosity through cross-linking of starch molecule, improved film forming of adhesive, improved water holding properties of the adhesive, improved wet tack in the presence of sodium hydroxide and affects the gel point of the total starch adhesive. In some aspects, the PEA may be present in an amount from about 1% to about 40% by weight of the adhesive composition, additionally or alternatively, from about 1% to about 10% by weight of the adhesive composition. Also, in some aspects, the starch may be present in an amount from about 60% to about 99% by weight of the adhesive composition, additionally or alternatively, from about 90% to about 99% by weight of the adhesive composition.

In an aspect, the PEA functions as a component of a binder for fiberglass. Herein, fiberglass refers to a strong, lightweight material that consists of thin fibers of glass that can be transformed into a woven layer or used as reinforcement. In some aspects, the PEA may be present in an amount from about 1% to about 40% by weight of the fiberglass binder composition, additionally or alternatively, from about 1% to about 10% by weight of the fiberglass binder composition. Also, in some aspects, the resin, for example, an epoxy or polyester, may be present in an amount from about 60% to about 99% by weight of the fiberglass binder composition, additionally or alternatively, from about 90% to about 99% by weight of the fiberglass binder composition.

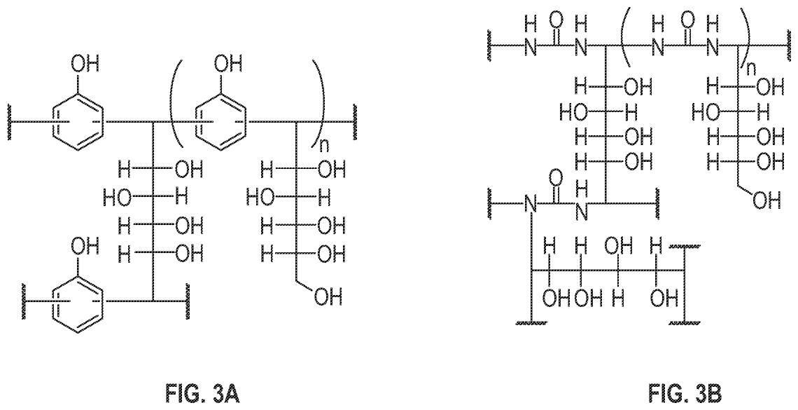

In an aspect, a PEA is used as a crosslinker and binding composition for naturally-occurring polysaccharides. Examples of polysaccharides suitable for use with a PEA of the present disclosure include but are not limited to guar, hydroxyethyl cellulose, carboxymethyl cellulose, and xanthan gum. An example of a polysaccharide crosslinker compound is depicted in FIG. 3A. In some aspects, the PEA may be present in an amount from about 1% to about 40% by weight of the binding composition, additionally or alternatively, from about 1% to about 10% by weight of the binding composition. Also, in some aspects, the resin may be present in an amount from about 60% to about 99% by weight of the binding composition, additionally or alternatively, from about 90% to about 99% by weight of the binding composition

In an aspect, a PEA functions as anti-plasticizing agent and/or strengthening agent for spun woven fibers. Nonlimiting examples of spun woven fibers include polyvinyl alcohol, cellulose acetate, cotton, hemp fibers, and combinations thereof. In an aspect, a PEA functions as a branching agent for a polyurethane product. An example of an urea crosslinker compound is depicted in FIG. 3B. In some aspects, the PEA may be present in an amount from about 1% to about 40% by weight of the anti-plasticizer composition, additionally or alternatively, from about 1% to about 10% by weight of the anti-plasticizer composition. Also, in some aspects, the fiberous material may be present in an amount from about 60% to about 99% by weight of the anti-plasticizer composition, additionally or alternatively, from about 90% to about 99% by weight of the anti-plasticizer composition.

In an aspect, the PEA may function as a branching agent with a polyester product. In one or more aspects, the PEA is used in combination with one or more monomers wherein the ratio of PEA to monomer may be about 1:10, alternatively about 1:5, or alternatively about 1:1. In some aspects, the PEA may be present in an amount from about 0.1% to about 10% by weight of the polyester composition, additionally or alternatively, from about 1% to about 5% by weight of the polyester composition. Also, in some aspects, the polyester may be present in an amount from about 00% to about 99.9% by weight of the polyester composition, additionally or alternatively, from about 95% to about 99% by weight of the polyester composition.

The PEA may be present in amounts effective for the desired application. For example, a PEA may be present in an amount of from about 0.01 weight percent (wt. %) to about 50 wt. %, alternatively from about 0.1 wt. % to about 5 wt. %, alternatively from about 10 wt. % to about 50 wt. %, or alternatively from about 0.01 wt. % to about 2 wt. % based on the total weight of the polymer composition.

In one or more aspects, the PEA comprises a nitrogen additive. Nitrogen additives suitable for use in the PEA are characterized by the presence of a nitrogen group such as urea, ammonium, amine salt, diamines, melamine, or a combination thereof. In some aspects, the nitrogen additive, when present, may be present in an amount from about 0.001% to about 95% by weight of the composition, additionally or alternatively, from about 1% to about 10% by weight of the composition.

In one or more aspects, the PEA comprises a solvent. Examples of solvents suitable for use in the PEA include, without limitation, water, methanol, ethanol, ethylene glycol, propylene glycol, ethylene glycol monobutyl ether, or a combination thereof. In other aspects, the solvent comprises a pH control additive such as a Lewis acid, a mineral acid, or a base. In some aspects, the solvent, when present, may be present in an amount from about 0.001% to about 95% by weight of the composition, additionally or alternatively, from about 1% to about 10% by weight of the composition.

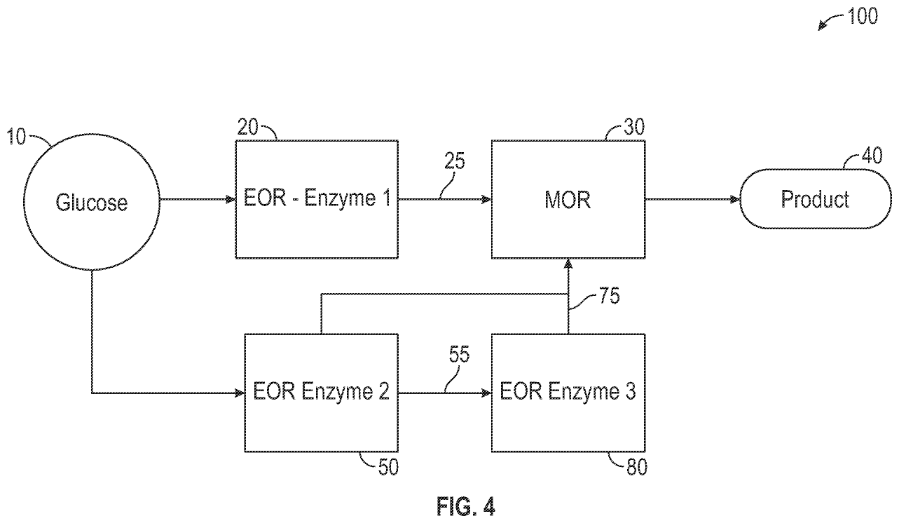

In an aspect, a method for the production of a PEA is depicted in FIG. 4. With reference to FIG. 4, a PEA (Product) 40 may be formed by a process 100 comprising contacting glucose 10 with a first enzyme (“Enzyme 1”) in an enzyme oxidation reactor (EOR) 20 under conditions suitable for the formation of an intermediate. Subsequent to contact with Enzyme 1 in the EOR 20, an intermediate formed may be conveyed via a conduit 25 to a metal oxidation reactor (MOR) 30 and subjected to conditions suitable for the formation of a product 40. As depicted in FIG. 4, in addition or in the alternative, glucose 10 is contacted with a second enzyme (“Enzyme 2”) in an EOR 50 under conditions suitable for the formation of an intermediate. In such aspects, the intermediate may be subsequently transferred to an MOR 30 via a conduit 55 and reacted under conditions suitable for formation of a product 40. Additionally or alternatively, in some aspects the intermediate formed from reaction with Enzyme 2 in the EOR 50 is transferred to a second EOR 80 and contacted with a third enzyme, Enzyme 3, under conditions suitable for the formation of an intermediate. Said intermediate may be subsequently conveyed via a conduit 75 to MOR 30 and subjected to conditions suitable for the formation of a product 40 (i.e., a PEA).

In some aspects, crosslinkers formed from PEAs of the present disclosure are characterized by the presence of an increased number of crosslinking sites per molecule when compared to a conventional crosslinker. Not intending to be bound by theory, the presence of a relatively high number of hydroxyl groups, for example, per weight amount, may provide for a relatively increased number of crosslinking sites. Consequently, the use of PEA-containing crosslinkers in the preparation of polymeric materials can lead to higher crosslinking and higher polymer viscosity than incumbent technologies.

In an aspect, the PEAs disclosed herein provide an environmentally friendly alternative to the synthesis of commercially important materials for a myriad of applications. For example, PEA-based polymers may display improved characteristics such as recyclability or biodegradability while reducing environmental, health, and safety concerns for production of the material. In some aspects, the PEAs of the present disclosure may be useful in applications including, but not limited to, the production of woven fibers (e.g., carpets, textile, molded parts, clothes and recycling); the production of construction fibers (e.g., fiberglass replacement, carbon fiber replacement, mineral wool); as insulation (e.g., automotive heat insulation, electroinsulation, roof, floor, ceiling, pipes); internal wall insulation, external wall insulation, acoustic insulation (e.g., buildings, automotive) as polymer additives (e.g., plasticizer, anti-plasticizer); and as property-modifying additives (e.g., improve mechanical strength, thermal stability, moisture absorption, chemical resistance in plastics).

In an aspect, the final products of one or more of the disclosed processes include but are not limited to glucose, gluconic acid, glucaric acid, glucodialdose, glucuronic acid, guluronic acid, and other C2-C6 monoacids, C2-C6 diacids, and combinations thereof.

The following are additional disclosures of the presently disclosed aspects:

A first aspect which is a composition and a process for a formaldehyde-free binding and strengthening agent utilizing a sugar derivative.

A second aspect which is the composition of the first aspect wherein the sugar derivative comprises of glucodialdose and/or 2-ketoglucose.

A third aspect which is the composition of any of the first through second aspects wherein the sugar derivative comprises of sodium gluconate and/or sodium glucarate liquid oxidation product comprising predominantly gluconate and glucarate anions with minor component species of n-keto-acids and C2-C6 diacids.

A fourth aspect which is the composition of any of the first through third aspects wherein the sugar derivative comprises of glutamic acid.

A fifth aspect which is the composition of any of the first through fourth aspects wherein the sugar derivative comprises of gluconic acid and glucaric acid oxidation product comprising predominantly gluconic acid and/or glucaric acid with minor component species of n-keto-acids and C2-C6 diacids.

A sixth aspect which is the composition of any of the first through fifth aspects wherein the sugar derivative comprises of sugar alcohols and polyols such as glycerol, mannitol, sorbitol.

A seventh aspect which is the composition any of the first through sixth aspects wherein the solvent comprises water, methanol, ethanol, ethylene glycol, propylene glycol, ethylene glycol monobutyl ether, pH control additives or a combination thereof.

An eighth aspect which is the composition of any of the first through seventh aspects further comprising one or more additional functional additives containing a nitrogen group.

A ninth aspect which is the composition of the eighth aspect wherein the nitrogen group additive comprises of urea, ammonium, amine salt.

A tenth aspect which is the composition of the ninth aspect wherein the amine salt comprises diamines.

An eleventh aspect which is the composition of the ninth aspect wherein the amine salt comprises melamine.

A twelfth aspect which is the composition of the seventh aspect wherein the pH control additive comprises Lewis acid/base, mineral acid/base.

A thirteenth aspect which is a crosslinking composition, comprising an oxidized sugar product; a nitrogen additive; and a solvent.

A fourteenth aspect which is the composition of the thirteenth aspect wherein the oxidized sugar product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

A fifteenth aspect which is the composition of any of the thirteenth through fourteenth aspects wherein the oxidized sugar product comprises less than about 5 wt. % maltose, maltotriose, fructose, higher molecular weight polysaccharides, oxidation products thereof or combinations thereof based on the total weight of the sugar derivative.

A sixteenth aspect which is the composition of any of the thirteenth through fifteenth aspects wherein the nitrogen additive comprises urea, ammonium, amine salt, diamines, melamine or a combination thereof.

A seventeenth aspect which is the composition of any of the thirteenth through sixteenth aspects wherein the solvent comprises water, methanol, ethanol, ethylene glycol, propylene glycol, ethylene glycol monobutyl ether, or a combination thereof.

An eighteenth aspect which is the composition of any of the thirteenth through seventeenth aspects wherein the pH control additive a Lewis acid, a mineral acid, or a base.

A nineteenth aspect which is a process for the dynamic vulcanization of blends of polypropylene and ethylene-propylene-diene rubber (PP/EPDM) comprising contacting any of the composition of claims 1-5 with a propylene monomer, ethylene monomer, diene monomer under conditions suitable for the production of thermoplastic vulcanizate.

A twentieth aspect which is a process for the production of a wood product comprising contacting one or more wood articles with any of the compositions of claims 1-8 under conditions suitable for the production of a wood end-use article.

A twenty-first aspect which is an adhesive comprising (i) a sodium silicate solution, (ii) a sugar oxidation product; (iii) urea; (iv) clay and (v) water.

A twenty-second aspect which is the adhesive of the twenty-first aspect wherein the oxidized sugar product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

A twenty-third aspect which is the adhesive of any the twenty-first through twenty-second aspects wherein the oxidized sugar product comprises less than about 5 wt. % maltose, maltotriose, fructose, higher molecular weight polysaccharides, oxidation products thereof or combinations thereof based on the total weight of the sugar derivative

A twenty-four aspect which is adhesive of one of the twenty-first through the twenty-third aspects, wherein the sugar oxidation product is present in the adhesive in an amount from about 0.1% to about 50% by weight of the adhesive.

A twenty-fifth aspect which is a process for adhering a first substrate to a second substrate, the process comprising applying the adhesive of one of the twenty-first through the twenty-fourth aspects to the first substrate, and contacting the adhesive applied to first substrate with the second substrate.

A twenty-sixth aspect which is an adhesive comprising (i) starch; (ii) a sugar oxidation product; and (iii) a boric acid.

A twenty-seventh aspect which is the adhesive of the twenty-sixth aspect, wherein the sugar oxidation product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

A twenty-eighth aspect, which is the adhesive of one of the twenty-sixth through the twenty-seventh aspects, wherein the sugar oxidation product comprises less than about 5 wt. % maltose, maltotriose, fructose, higher molecular weight polysaccharides, oxidation products thereof or combinations thereof based on the total weight of the sugar derivative.

A twenty-ninth aspect, which is the adhesive of one of the twenty-sixth through the twenty-eighth aspects, wherein the sugar oxidation product is present in the adhesive in an amount from about 0.1% to about 50% by weight of the adhesive.

A thirtieth aspect, which is a process for adhering a first substrate to a second substrate, the process comprising: applying the adhesive of one of the twenty-sixth through the twenty-ninth aspects to the first substrate; and contacting the adhesive applied to first substrate with the second substrate.

A thirty-first aspect, which is the process of the thirtieth aspect, further comprising allowing the adhesive to cure.

### EXAMPLES

The aspects having been generally described, the following example is given as particular aspects of the disclosure and to demonstrate the practice and advantages thereof. It is understood that the example is given by way of illustration and is not intended to limit the specification or the claims in any manner.

### Example 1

### Urea-Formaldehyde System as Control:

A two-step process was adopted to make a urea-formaldehyde (UF) resin as a control. The steps were conducted in a single reactor to yield a final product having a formaldehyde/urea mole ratio of about 1.48. In the first step, the reaction was carried out in alkaline condition (pH 7.8-8.5, 90° C., 1 h). Only a portion of the total urea to use in the finished product was added to the reactor to yield a reaction product with a mole ratio of formaldehyde/urea mole ratio of 2. The overall condition allowed the addition reaction (i.e., methylation) to take place. In the second step, the temperature was decreased to 80° C. and the pH adjusted to 4.6-5.5 (acid step) for the condensation reaction to occur. The remaining amount of urea was added at the end of the reaction to consume the excess amount of formaldehyde and produce a resin with a formaldehyde/urea mole ratio of 1.48. The urea was dissolved in formaldehyde; the mixture reacted quickly and changed from a transparent liquid (water-like) to a milky-white dispersion during addition polymerization phase. At the end of the process, the reaction product was a dispersion with a targeted viscosity of 150 cp (typical target: 150-500 cp). The material gelled within 24-36 hours. Fourier-transform infrared spectroscopy with attenuated total reflection (FTIR/ATR) technique was used to determine the appearance of new groups or linkages created during the reaction between different components.

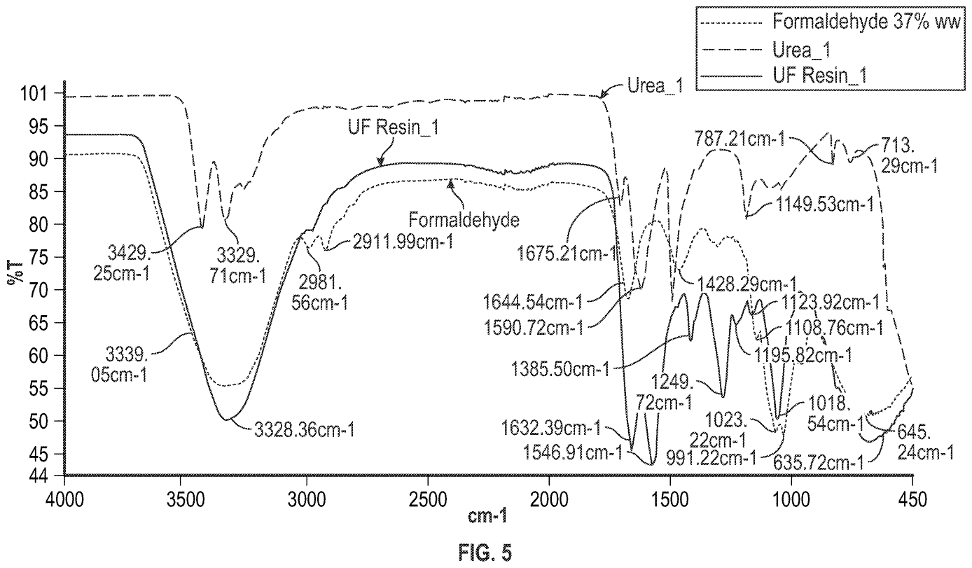

FTIR/ATR spectra of the resin and the raw materials (formaldehyde and urea) are shown in FIG. 5 followed by peak assignment in Table 1. The spectra highlight differences and changes between the reaction product and the raw materials.

TABLE 1

| Observed Band (cm⁻¹) | Functional group |
|---|---|
| 3328.36 | N—H stretching mode |
| 1632.39 | Amide I, mainly due to C═O stretching |
| 1546.91 | Amide II, mixture of C—N and N—H |
| | deformation |
| 1385.50 | C—H stretching of the CH₂OH group |
| 1249.72 | —OH, deformation of CH₂OH |
| 1123.92 | Asymmetric stretching of >N—CH₂ < N |
| 1018.54 | C—O stretch in methylol |

### Example 2

### Gluconate-Urea Resin Formulation:

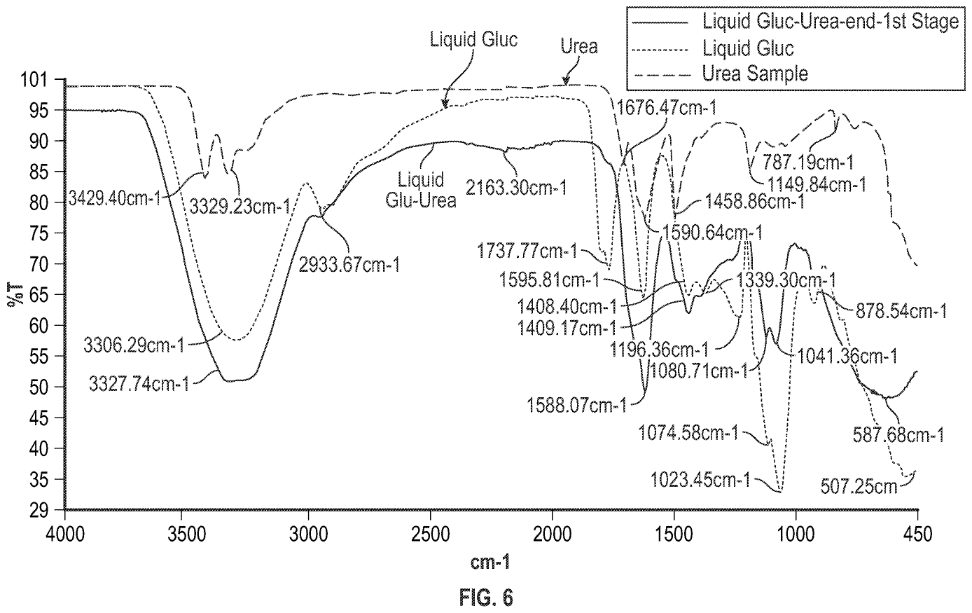

Liquid gluconate (‘Liquid Gluc’) solution has 25 wt. % sodium gluconate, 35 wt. % D-gluconic acid and 40 wt. % water. A two-step process similar to the one used for making Urea-Formaldehyde was adopted. The steps were conducted in a single reactor to yield a final product a Liquid Gluconate/urea (LG60/U) mole ratio of about 1.47. FTIR/ATR spectra of the resin and the raw materials are shown in FIG. 6 followed by peak assignment in Table 2.

TABLE 2

| Observed Band (cm⁻¹) | Functional group |
|---|---|
| 3327.74 | N—H stretching mode |
| 1588.07 | Amide II, mixture of C—N and N—H |
| | deformation |
| 1134 | Asymmetric stretching of >N—CH₂ < N |

### Example 3

### AQUACORE X40-Urea Resin Formulation:

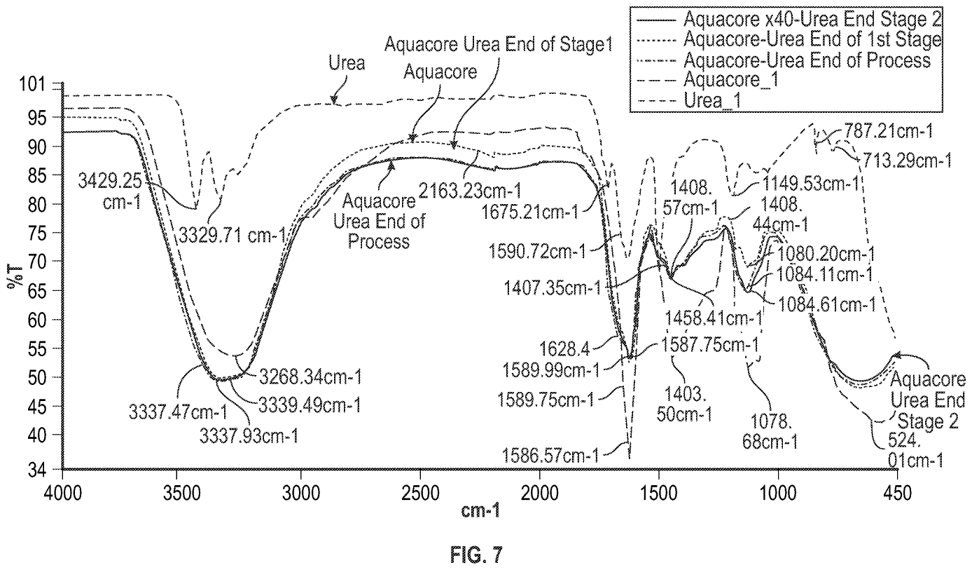

AQUACORE X40 is a proprietary blend of gluconic acid, glucaric acid and water manufactured by Solugen Inc. A two-step process similar to the one used for making Urea-Formaldehyde was adopted. The steps were conducted in a single reactor to yield a final product AQUACORE X40/urea (X40/U) mole ratio of about 1.47. FTIR/ATR spectra of the resin and the raw materials are shown in FIG. 7 followed by peak assignment in Table 3.

TABLE 3

| Observed Band (cm⁻¹) | Functional group |
|---|---|
| 3337.74 | N—H stretching mode |
| 1628.40 | Amide I, mainly due to C═O stretching |
| 1589.99 | Amide II, mixture of C—N and N—H deformation |
| 1123.92 | Asymmetric stretching of >N—CH₂ < N |
| 1084.11 | C—O stretch |

Table 4 provides details on the observations of the process for making resins with Liquid Gluconate 60 and AQUACORE X40 as drop-ins in UF formulations.

TABLE 4

| | | Liquid | Aquacore |
|---|---|---|---|
| Process Stage | UF | Gluconate | X40 |
| Original material, pH | | 3.16 | 4.51 |
| Onset Stage 1 pH, | 7.8-8.0 | 8.53 | 8.39 |
| adjusted to 7.8-8.5 | | | |
| End Stage 1, pH | 5.98 | 9.08 | 8.94 |
| Onset Stage 2 pH, | 5.04 | 4.69 | 4.85 |
| adjusted to 4.8-5.0 | | | |
| Viscosity (mPa-s) | Build-up | No visual | No visual |
| during reaction | (not recorded) | change | change |
| End Stage 2, pH | 4.83 | 5.09 | 5.29 |
| Adjust to 8.0 to | 8.56 | 8.61 | 9.12 |
| terminate reaction | | | |
| Viscosity final | 154 | 16 | 4 |
| product (mPa-s) | | | |
| Agitation speed (rpm) | 300 | 300 | 300 |

### Example 4

Reaction with Boric Acid

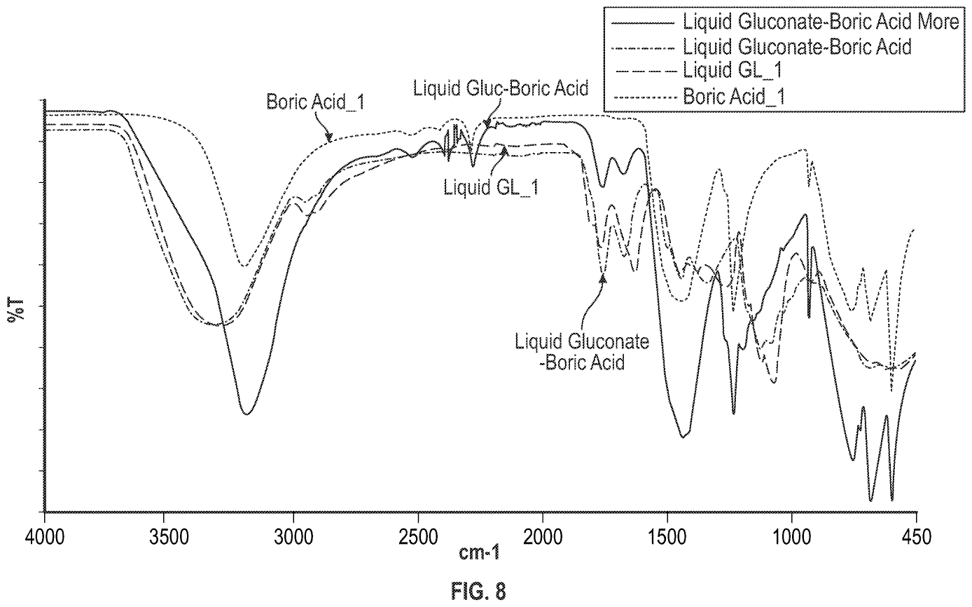

Boric acid forms strong bonds with hydroxyl groups due to presence of vacant d-orbital in boron, which causes it to rapidly react with various nucleophiles to form complexes. Hence, the boric acid can be used as a cross-linker for hydroxyl-containing polymers. FTIR/ATR spectra of the reactants and products for reactions of Liquid gluconate with boric acid are shown in FIG. 8 followed by peak assignment in Table 5.

TABLE 5

| Observed Band (cm⁻¹) | Functional group |
|---|---|
| 639.42 | C—B stretch, aliphatic boron compound |
| 1079.65 | C—O stretch |
| 1293.39 | OH in-plane bend; hydroxy compound |
| 1403.00 | B—O bend |
| 1638.83 | B—O bend |
| 1725.41 | Carbonyl/carboxyl |
| 3338.37 | Confirms existence of hydroxyl (OH) |

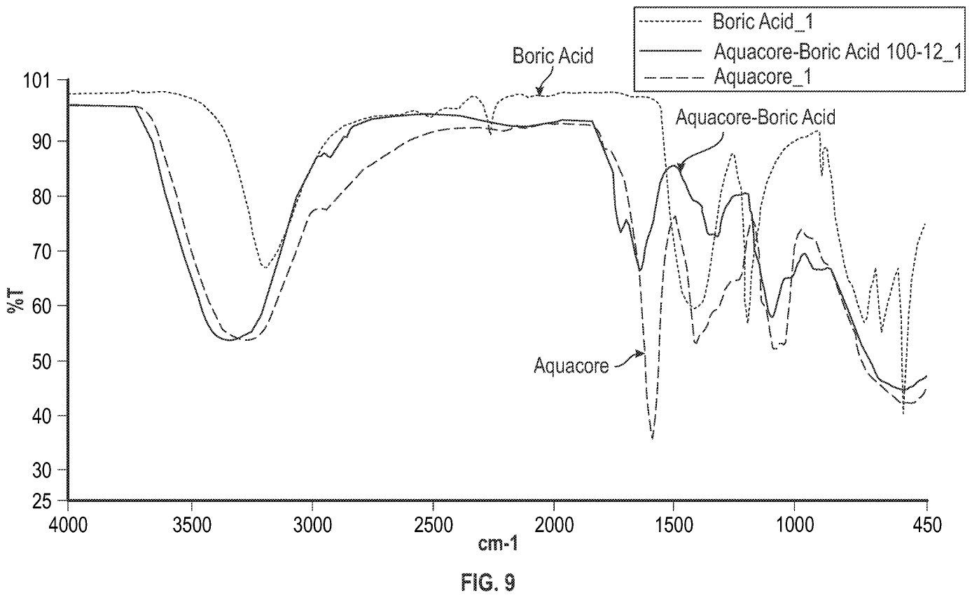

FTIR/ATR spectra of the reactants and products for reactions of AQUACORE X40 with boric acid are shown in FIG. 9 followed by peak assignment in Table 6.

TABLE 6

| Observed Band (cm⁻¹) | Functional group |
|---|---|
| 543.78 (typical 500-700 | C—B stretch |
| for C-Halide stretch) | |
| 911.55 | C—H out of plane |
| 1071.82 (typical | C—O stretch coupled with C—O |
| band 1000-1200) | bending of C—OH of carbohydrate |
| 1319.47 | B—O bend |
| 1643.13 | B—O bend |
| 1718.74 | Carboxylic acid /carboxyl |
| 3370.32 | OH |

### Example 5

Reaction of AQUACORE with CYMEL® NF3030

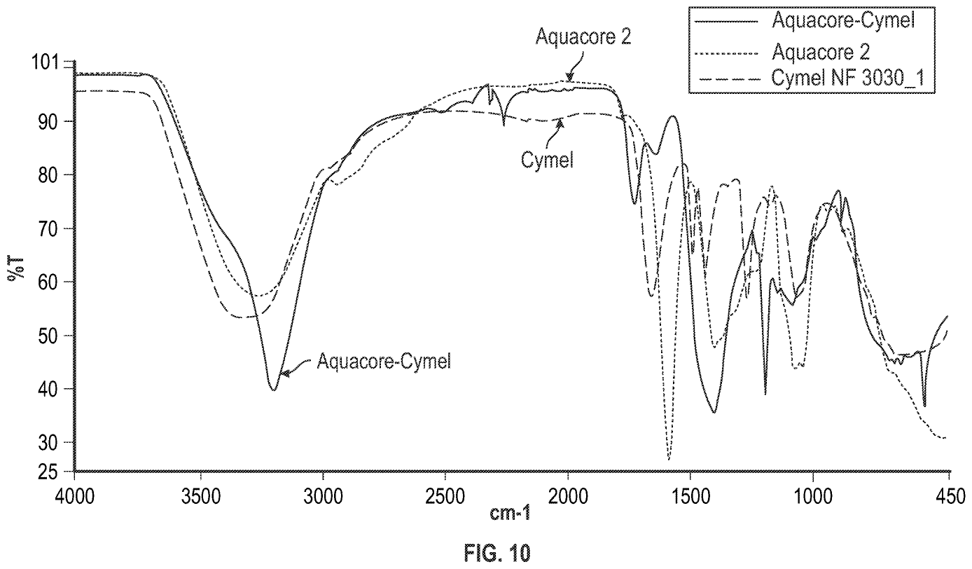

CYMEL® NF3030 is a commercially available amine-based crosslinker. FTIR/ATR spectra of the reactants and products for reactions of AQUACORE X40 with CYMEL are shown in FIG. 10 followed by peak assignment in Table 7.

TABLE 7

| Observed Band (cm⁻¹) | Functional group |
|---|---|
| 1146, 1271 (typical | Hydroxyl |
| band 1000-1200) | |
| 1404 ((typical | Hydroxyl |
| band 1200-1600) | |
| 1583 | Carboxylate |
| | (carboxylic acid salt) |
| 1662 | Amide |
| 3210 (typical | Confirm |
| band 3250-3670) | existence of —OH |

### Example 6

Reaction of Liquid Sodium Silicate with Liquid Gluconate and Gluconic Acid

Sodium silicate (STIXSO® RR from PQ Corporation) and liquid gluconate or gluconic acid were mixed in different ratios. Then the mixture was used to bond wooden sticks. Table 8 and Table 9 summarizes mixing ratio and observations for liquid gluconate and gluconic acid (50 wt % solution in water), respectively.

TABLE 8

| | Run 1 | Run 2 | Run 3 | Run 4 | Run 5 |
|---|---|---|---|---|---|
| | Weight | Weight | Weight | Weight | Weight |
| | (% | (% | (% | (% | (% |
| RM | solids) | solids) | solids) | solids) | solids) |
| Soldium | 40 | 98.5 | 92.7 | 85.7 | 79.1 |
| Silicate | | | | | |
| STIXSO RR | | | | | |
| (40% Solids | | | | | |
| Liquid | 60 | 1.5 | 7.3 | 14.3 | 20.9 |
| Gluconate 60 | | | | | |
| (pH Liquid | | | | | |
| Gluconate 60: | | | | | |
| 3.24 | | | | | |
| -Add Liquid | | | | | |
| Gluconate 60 | | | | | |
| in small | | | | | |
| increments for | | | | | |
| 10-15 minutes | | | | | |
| Observations | Gel | Smooth | Turbidity | Turbidity | Turbidity |
| | | | then | then | then |
| | | | redissolved | redissolved | redissolved |
| Bond, wood- | N/A | Good | Good bond | Good bond | Good bond |
| to-wood | | bond | | | |
| Cured at | | | | | |
| 150° C., time | | | | | |
| 10-30 min. | | | | | |

TABLE 9

| | Run 1 | Run 2 | Run 3 | Run 4 | Run 5 |
|---|---|---|---|---|---|
| | Weight | Weight | Weight | Weight | Weight |
| | (% | (% | (% | (% | (% |
| RM | solids) | solids) | solids) | solids) | solids) |
| Soldium Silicate | 87.8 | 81.9 | 76.1 | 65.1 | 51.3 |
| STIXSO RR (40% | | | | | |
| Solids | | | | | |
| Gluconic Acid 50 | 12.2 | 18.1 | 23.9 | 34.9 | 48.7 |
| (pH 10.97) | | | | | |
| -Initial pH Gluconic | | | | | |
| Acid 50: 1.59 | | | | | |
| -Adjust pH of | | | | | |
| Gluconic Acid 50 to | | | | | |
| pH 10.8 | | | | | |
| -Add Glconic Acid | | | | | |
| 50 to STIXSO RR in | | | | | |
| small increments for | | | | | |
| 30-45 minutes | | | | | |
| Observations: | Smooth | Smooth | Smooth | Smooth | Smooth, |
| Solution: | | | | | gels |
| | | | | | overnight |
| Bond, wood-to-wood | N/A | Good | Good | Good | |
| Cured at 150° C., | | bond | bond | bond | |
| time 10-30 min. | | | | | |

It was speculated that the pH of Gluconic Acid (GO50), Liquid Gluconate 60 (LG60), and Aquacore X40 (X40) was lower than required (1 to 4) as the pH of sodium silicate is approximately 11 and the large difference in pH during blending caused precipitation of solid particles. Hence the pH of Gluconic Acid, Liquid Gluconate 60, and Aquacore X40 was increased by mixing with sodium hydroxide to 11.0, 5.18, and 9.58, respectively. Then blends of Gluconic Acid, Liquid Gluconate 60, and Aquacore X40 with sodium silicate were made such that blend was stable with no precipitation. The amount of Gluconic Acid, Liquid Gluconate 60, and Aquacore X40 in the blend was 30-35, 7-10, and 20-30 wt. %, respectively.

These adhesive blends were used to bond Birch plywood specimens. The dimensions of the plywood were 1 inch (in.) wide, ⅛ in. thick and 5 in. long, while the bonded length was 1 in. The bonded plywood specimens were pulled (to perform a lap shear test) with Instron Model 5569 (50 kN) load cell; a 10 lbf preload was applied prior to straining. The samples were pulled until the adhesive failed, and the load and extension were measured. The data in Table 10 summarizes the bond strength. The bond strength of the adhesive blends that contain Solugen additives is sufficient for plywood applications.

TABLE 10

| Adhesive blend | Bond strength (lbf) |
|---|---|
| Liquid silicate (LS) | 218 |
| LS-GO50 blend | 166 |
| LS-X40 blend | 138 |
| LS-LG60 blend | 60 |

### Example 7

### Gluconic Acid in Starch-Based and Liquid-Silicate-Based Adhesives

### Synthesis of Liquid Silicate Adhesives

Gluconic acid 50 pH was adjusted to 11.31 using 50% sodium hydroxide (NaOH) solution. This pH-adjusted gluconic acid was mixed with OXY 42 liquid sodium sodium silicate solution, commercially available from OxyChem, and with Stixso™ liquid sodium silicate solution, commercially available from PQ corporation, with gluconic acid being 30 wt. % of the solution. The mixing was done with agitation speed of 300 rpm.

### Synthesis of Starch-Based Adhesives

Starch adhesive was made using the standard Stein-Hall process typically employed in making starch-based adhesives in the corrugated cardboard industry. Briefly, carrier starch (Pearl Corn Starch, which is representative of the starch typically used to prepare adhesive for making corrugated boards) was by mixing water, pearl starch and 50% sodium hydroxide solution at 40-50° C. Then a mix of 3.5 wt. % aqueous solution of borax pentahydrate (Neobor®), water and starch (raw starch) were added to carrier starch and the temperature was maintained below 40° C. The final formulation of the starch adhesive is listed in Table 11.

TABLE 11

| | Component | Wt. % |
|---|---|---|
| 1 | Water | 26.8 |
| 2 | Starch | 3.9 |
| 3 | 50% NaOH | 1.1 |
| 4 | Borax | 8.5 |
| 5 | Water | 39.1 |
| 6 | Starch | 20.6 |

Note:
1, 2, and 3 are components of carrier starch and 4, 5, and 6 are components of raw starch.

### Testing of Adhesive Strength

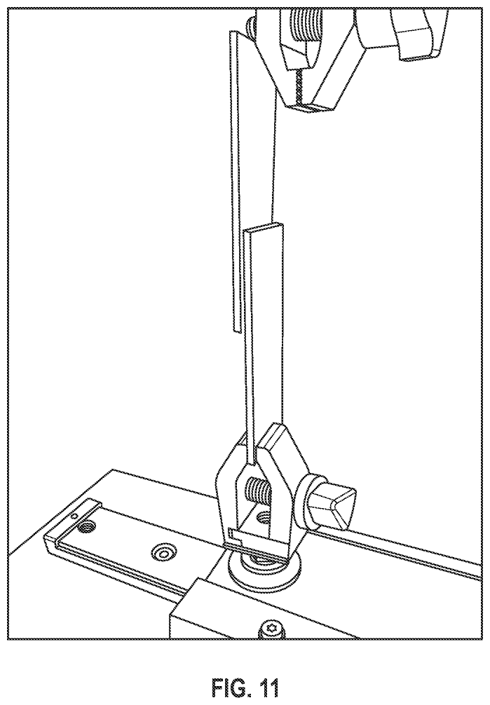

1-inch-wide and 5-inch-long tabs were cut out of the double-face kraft corrugated board substrate with the flutes aligned in the long direction of the tabs. The various adhesive formulations were applied onto one side of a tab to cover the extremity 1 in² of the tab. Then, immediately, a second tab (not covered with adhesive) was brought in contact with the adhesive-covered surface of the first tab to create a lap bond of 1 inch×1 inch, equivalent to 1 in². A glass sheet was immediately placed on the bonds, and an 8-lb weight was placed on the glass for compression. The tabs were dried at room temperature for 24 hours for the bonds made with the blends of Gluconic Acid 50 and liquid sodium silicate. For the starch-based adhesives, the specimens were placed in a drying oven set at 150° C. for 10 minutes to activate the raw starch (gel the starch and change it into an adhesive). Then the bonded samples were removed from the oven and dried at room temperature under compression for 24 hours before strength evaluation. The shear strength of the bonds was measured and recorded using a custom set-up as shown in FIG. 11. One of the clamps is connected to a load cell to measure force. The bonded samples were pulled apart until the cardboard samples fracture or the adhesive failed.

### Results and Conclusion

The adhesive strengths of the OXY 42-gluconic acid blend, the Stixso-gluconic acid blend, and the starch adhesive were 220 N, 202 N, and 178 N, respectively. These results demonstrate that gluconic acid can be used to improve the strength of adhesive for corrugated cardboard formulations.

While aspects of the presently disclosed subject matter have been shown and described, modifications thereof can be made by one skilled in the art without departing from the spirit and teachings of the subject matter. The aspects described herein are exemplary only, and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the presently disclosed subject matter. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A crosslinking composition, comprising:
an oxidized sugar product;
a nitrogen additive; and
a solvent.

2. The composition of claim 1, wherein the oxidized sugar product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

3. The composition of claim 1, wherein the oxidized sugar product comprises less than about 5 wt. % maltose, maltotriose, fructose, higher molecular weight polysaccharides, oxidation products thereof or combinations thereof based on the total weight of the sugar derivative.

4. The composition of claim 1, wherein the nitrogen additive comprises urea, ammonium, amine salt, diamines, melamine or a combination thereof.

5. The composition of claim 1, wherein the solvent comprises water, methanol, ethanol, ethylene glycol, propylene glycol, ethylene glycol monobutyl ether, or a combination thereof.

6. The composition of claim 1, wherein the solvent comprises a pH control additive.

7. The composition of claim 6, wherein the pH control additive a Lewis acid, a mineral acid, or a base.

8. A process for the dynamic vulcanization of blends of polypropylene and ethylene-propylene-diene rubber (PP/EPDM), comprising:
contacting the composition of claim 1 with a propylene monomer, ethylene monomer, diene monomer under conditions suitable for the production of thermoplastic vulcanizate.

9. A process for the production of a wood product, the method comprising:
contacting one or more wood articles with the composition of claim 1 under conditions suitable for the production of a wood end-use article.

10. An adhesive, comprising:
(i) a sodium silicate solution;
(ii) a sugar oxidation product;
(iii) urea;
(iv) clay; and
(v) water.

11. The adhesive of claim 10, wherein the sugar oxidation product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

12. The adhesive of claim 10, wherein the sugar oxidation product comprises less than about 5 wt. % maltose, maltotriose, fructose, higher molecular weight polysaccharides, oxidation products thereof or combinations thereof based on the total weight of the sugar derivative.

13. The adhesive of claim 10, wherein the sugar oxidation product is present in the adhesive in an amount from about 0.1% to about 50% by weight of the adhesive.

14. A process for adhering a first substrate to a second substrate, the process comprising:
applying the adhesive of claim 10 to the first substrate; and
contacting the adhesive applied to first substrate with the second substrate.

15. An adhesive, comprising:
(i) starch;
(ii) a sugar oxidation product; and
(iii) a boric acid.

16. The adhesive of claim 15, wherein the sugar oxidation product comprises an aldaric acid, uronic acid, glucaric acid, gluconic acid, glucuronic acid, glucose oxidation products, gluconic acid oxidation products, disaccharides, oxidized disaccharides, n-keto-acids, C2-C6 diacids, galactonic acid, galactaric acid, glutamic acid, glucodialdose, 2-ketoglucose, glucodiamine, glycoaldehyde, glyoxal, salts thereof, lactones thereof or combinations thereof.

17. The adhesive of claim 15, wherein the sugar oxidation product comprises less than about 5 wt. % maltose, maltotriose, fructose, higher molecular weight polysaccharides, oxidation products thereof or combinations thereof based on the total weight of the sugar derivative.

18. The adhesive of claim 15, wherein the sugar oxidation product is present in the adhesive in an amount from about 0.1% to about 50% by weight of the adhesive.

19. A process for adhering a first substrate to a second substrate, the process comprising:
applying the adhesive of claim 15 to the first substrate; and
contacting the adhesive applied to first substrate with the second substrate.

20. The process of claim 20, further comprising allowing the adhesive to cure.
